(19) United States
(12) Patent Application Publication
(10) Pub. No.: US 2025/0315763 A1
(43) Pub. Date: Oct. 9, 2025

(54) SYSTEMS AND METHODS FOR AUTOMATIC AUDIT INFORMATION LABELLING

(71) Applicant: ROYAL BANK OF CANADA, Toronto (CA)

(72) Inventors: Erin Elizabeth Shelton, Toronto (CA); Preet Kanwal Singh, Toronto (CA); Vincent Huang, Toronto (CA)

(21) Appl. No.: 18/960,490

(22) Filed: Nov. 26, 2024

Related U.S. Application Data
(60) Provisional application No. 63/602,763, filed on Nov. 27, 2023.

(51) Int. Cl. G06Q 10/0635; G06F 16/338; G06F 16/35

(52) U.S. Cl. CPC G06Q 10/0635; G06F 16/338; G06F 16/35

(57) ABSTRACT

A zero-shot classifier can be used for the automatic labelling of audit information. An issue description in the audit information is compared to each of a plurality of risk/sub-risk descriptions using a zero-shot classifier in order to determine a plurality of risk/sub-risks that are most relevant to the issue description.

### RELATED APPLICATIONS

This application claims priority to U.S. Provisional Application No. 63/602,763 filed Nov. 26, 2023, entitled “Systems And Methods For Automatic Audit Information Labelling,” the entire contents of which are incorporated herein by reference in their entirety for all purposes.

### TECHNICAL FIELD

The current disclosure relates to the automatic processing of internal audit information and in particular to systems and methods for automatic labelling of internal audit information.

### BACKGROUND

Audit teams frequently report on the themes and risks present in issues that were raised during audit engagements. During the creation of an issue, auditors write a description of the issue, and manually assign a single risk label from a risk taxonomy of the entity being audited. The risk taxonomy provides a hierarchical grouping of risks and sub-risks along with descriptions of the risks/sub-risks. Historically, reporting on issue risks and themes was facilitated by a highly time consuming and subjective review of issue descriptions and assigned risks. This manual approach relies on auditor familiarity and expertise with respect to the entire risk taxonomy, and is known be prone to human error. Additionally, a single risk label may not sufficiently capture the full scope of risks described within an audit issue.

An additional, alternative and/or improved process for processing audit information is desirable.

### BRIEF DESCRIPTION OF THE DRAWINGS

Further features and advantages of the present disclosure will become apparent from the following detailed description, taken in combination with the appended drawings, in which:

FIG. 1 depicts a process for automatic labelling of audit information;

FIG. 2 depicts a portion of a risk taxonomy;

FIG. 3 depicts a system for automatic labelling of audit information;

FIG. 4 depicts a user interface display highlighting relevant portions of audit information;

FIG. 5 depicts a portion of a user interface that can be used in a system such as that depicted in FIG. 3;

FIG. 6 depicts a method of automatically labelling audit information;

FIG. 7 depicts a method of highlighting relevant portions of audit information;

FIGS. 8A-11B depict graphs of testing results;

FIG. 12 depicts a further system for automatic labelling of audit information;

FIG. 13 depicts a method of automatically labelling audit information;

FIG. 14 depicts a graph of generative LLM positive responses; and

FIGS. 15A and 15B depict Jaccard similarities between original and perturbed sets.

### DETAILED DESCRIPTION

In accordance with the present disclosure there is provided a method of automatically labelling issues from an internal audit, the method comprising: receiving an issue description comprising a text description of an internal audit issue; combining the text description with a plurality of hypotheses texts to generate a plurality of description: hypothesis pairs, each of the plurality of hypotheses texts associated with a sub-risk description for a sub-risk in a risk taxonomy; applying each of the description: hypothesis pairs to a zero-shot classification model to determine a label score for the sub-risk associated with the hypothesis; determining relevance of each sub-risk in the risk taxonomy to the issue description; and outputting a plurality of relevant sub-risks associated with the issue description.

In a further embodiment of the method, determining the relevance of each sub-risk in the risk taxonomy to the issue description comprises: applying a generative large-language model (LLM) to the issue description and the hypothesis texts to determine if the issue description is relevant to the hypothesis text.

In a further embodiment of the method, only issue descriptions with a label score above a threshold are applied to the generative LLM.

In a further embodiment of the method, the hypothesis text applied to the generative LLM is a simplified version of the hypothesis text applied to the zero-shot classification model.

In a further embodiment of the method, determining the relevance of each sub-risk in the risk taxonomy to the issue description comprises: filtering each of the label scores to identify a top n labels for the issue description, where n is a whole number greater than 1.

In a further embodiment of the method, the filtering comprises: aggregating a plurality label scores for hypothesis associated with the same sub-risk; and filtering on the aggregated label scores.

In a further embodiment of the method, the filtering further comprises: for all hypothesis associated with sub-risks grouped by a common risk, filtering to a top m sub-risks for the risk grouping, where m is a whole number less than n.

In a further embodiment of the method, the method further comprises cleaning the issue description to normalize the issue description.

In a further embodiment of the method, each of one or more of the sub-risks in the risk taxonomy are associated with a plurality of hypothesis.

In a further embodiment of the method, the plurality of hypothesis are based on different portions of the sub-risk description in the risk taxonomy.

In a further embodiment of the method, the plurality of hypothesis are based on different phrasing of a same portion of the same sub-risk description in the risk taxonomy.

In a further embodiment of the method, the method further comprises: receiving a hypothesis; determining relevant portions of the issue description to the selected hypothesis; and highlighting the relevant portions of the issue description in a user interface display.

In a further embodiment of the method, determining the relevant portions of the issue description comprises: generating a plurality of text groupings based on pairings of sentences in issue description; applying each of text groupings, combined with the hypothesis, to the zero shot classifier to provide a text group scoring for the hypothesis; and selecting the text grouping with the highest text group scoring for highlighting.

In accordance with the present disclosure there is further provided a non-transitory computer readable medium storing instructions, which when executed by a processor of a computing device configure the computing device to perform a method according to any of the above methods.

In accordance with the present disclosure there is further provided a computing system comprising: a processor for executing instructions; and a memory storing instructions, which when executed by the processor configure the computing system to perform a method according to any one of the above methods.

Issue descriptions from audits can be automatically processed using a zero-shot intelligent classifier in order to identify relevant risk classifications. A Zero-shot Intelligent Classifier (ZINC) is a model and visualization method to identify relevant risk classifications from audit Issue text descriptions. The ZINC model receives audit issue text as input, together with a set of risk/sub-risk descriptions, and outputs a number, such as 6, of the top sub-risks for the respective Issue. The model's multi-label classification provides a significant advantage over the current audit Issue labeling approach, which is manual and prone to error. Further, by using the zero-shot model, the classification can be accomplished without requiring training data, which may be limited. Further, the zero-shot classifier is able to classify new risks/sub-risks without requiring the model to be retrained.

ZINC enables Internal Audit teams to perform reporting and regulatory processes in a more efficient, consistent, and higher quality manner. The current process is highly subjective and auditors may not always agree on a single risk label to describe an issue. ZINC provides a significant improvement over the existing method regarding the assignment of risk labels to audit issues. ZINC allows auditors to easily and efficiently analyze risk themes and scope of coverage over performed audits, reducing manual effort. Multi-label classification of risks gives auditors a more detailed and accurate picture of the risk landscape, which provides an advantage in the Internal Audit team's audit engagements and regulatory reporting.

ZINC performs multi-label classification of risks through the use of a textual entailment approach with a language model. In addition to classifying the issues, the ZINC model may also provide visualization of portions of the issue description that are important for the classification. This visualization method allows a user to quickly identify the part of text that best corresponds to a label. For input text of larger length, the visualization method can provide the user with a succinct segment of text that identifies why the selected label is appropriate for the input text. For Internal Audit use-cases, this allows auditors to efficiently identify relevant risks and root causes from Issue descriptions, without requiring large amounts of time or specific subject matter expertise.

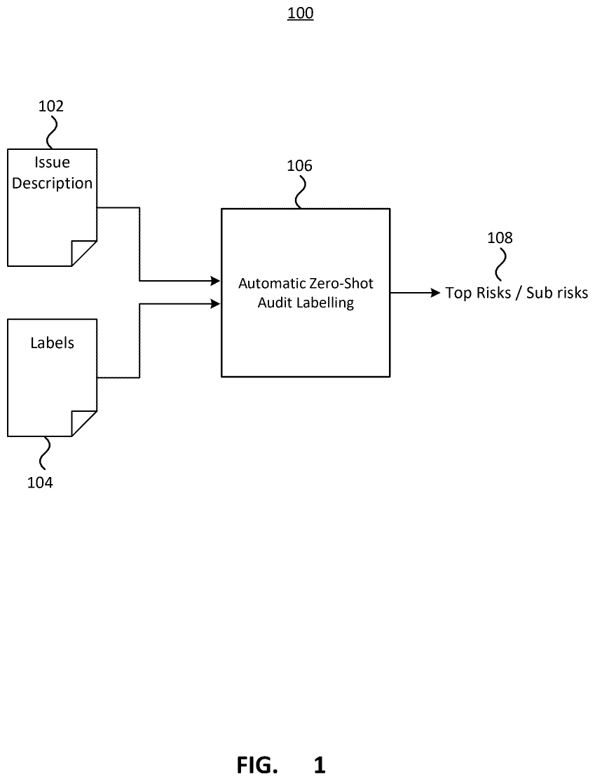

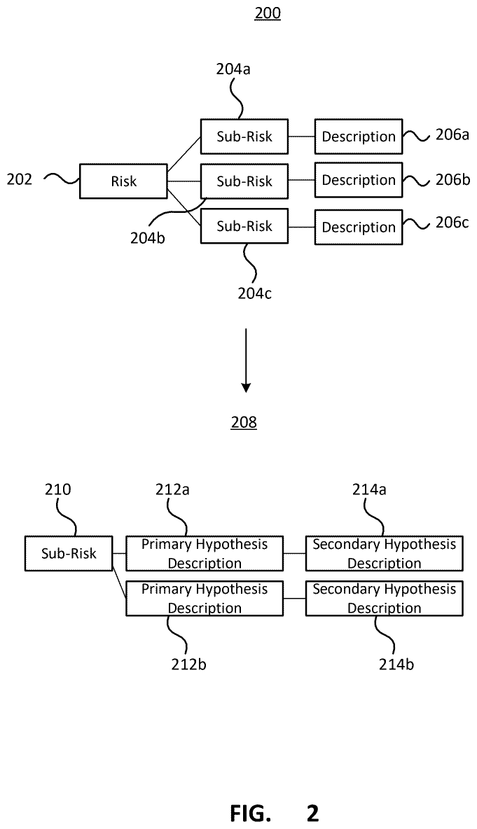

FIG. 1 depicts a process for automatic labelling of audit information. The labelling process 100 receives an issue description 102 along with possible label descriptions 104. The issue description and label descriptions of risks/sub-risks are provided to an automatic zero-shot audit labelling model 106, which processes the issue description and label descriptions in order to determine the most relevant risk/sub-risk labels to the issue description. The risk/sub-risk labels 108 are output and can be used for various down-stream processes, including for example searching for relevant audit issues, grouping audit issues together, evaluating an audit process, aggregating audit information, reporting, etc.

As described in further detail below, the zero-shot audit labelling model 106 receives the issue description and combines it with each risk/sub-risk label. Each pair is evaluated by the classifier to identify a probability that the risk/sub-risk label is relevant to the issue description. The issue description: risk label pairs can be ordered based on the determined probabilities in order to provide the most relevant labels.

As described above, the model processes an issue description and risk label description. The issue description is retrieved from audit information and comprises text that describes the details of an audit Issue. The issue description is initially prepared by an audit professional and may be further processed in order to normalize the text. The risk labels are generated from a risk taxonomy used by the audit team.

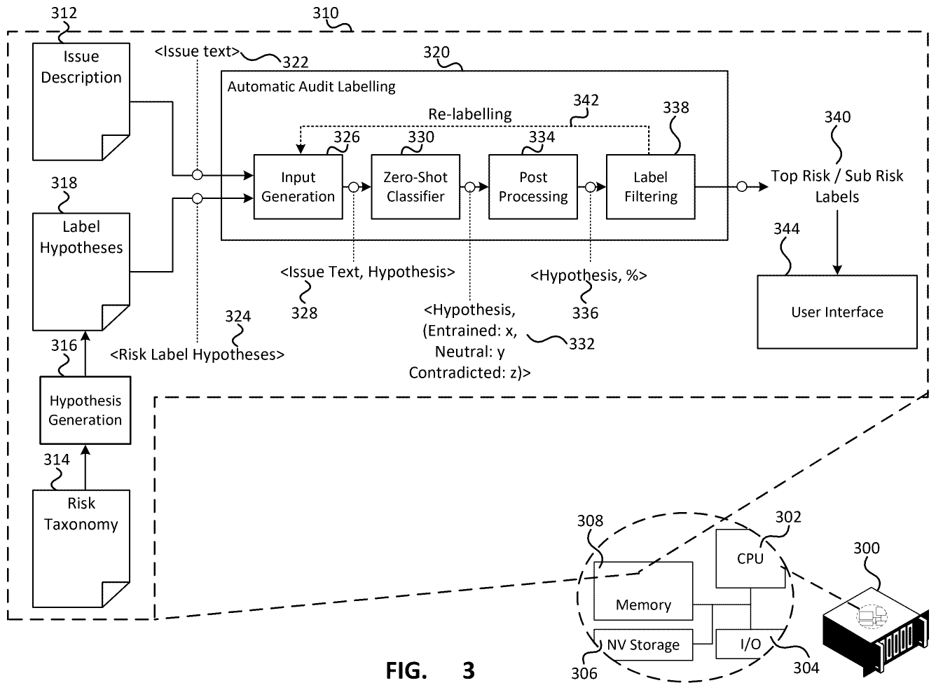

FIG. 2 depicts a portion of a risk taxonomy. FIG. 2 depicts a portion of the risk taxonomy 200. As depicted, a risk 202 can be associated with one or more sub-risks 204a, 204b, 204c each of which includes a description 206a, 206b, 206c of the risk/sub-risk. Although only a single risk 202 is depicted in the taxonomy 200, it will be appreciated that multiple risks/sub-risks are included. The risk taxonomy 200 may be an existing taxonomy used by audit teams in classifying audit issues. The risk taxonomy 200 is used to generate label descriptions 208 used for the issue classification.

The label descriptions 208 comprise text descriptions of each risk/sub-risk from the risk taxonomy 200 formed as hypotheses about the issue description. For example, a sub-risk may be “Inaccurate financial reporting” and the risk description may be “inaccurate notes and disclosures related to financial reporting”. A hypothesis for the label may be for example “Failure through inaccurate notes and disclosures related to financial reporting.” The classification processes determines the probability that the issue description is related to the hypothesis. For each sub-risk in the taxonomy, a plurality of hypotheses can be generated. A single sub-risk 210 is depicted as being associated with two primary hypothesis descriptions 212a, 212b. For example, a single risk in the risk taxonomy may cover multiple scenarios or cases, each of which can be provided as a single risk label. Further, as depicted, each hypothesis may be formed in multiple ways, depicted as secondary hypothesis descriptions 214a, 214b. For example, risk labels may include both a primary and secondary description which may be, for example a broad description and a more detailed description. Further still, the description may be formatted as separate hypotheses, with one formed as a positive hypothesis and one formed as a negative hypothesis.

As will be appreciated, the risk labels 208 may be provided in various different formats, however provide one or more label hypothesis descriptions each associated with a risk or sub-risk in the risk taxonomy. The risk label information 208 is used to determine which risks/sub-risks are most relevant to an issue description.

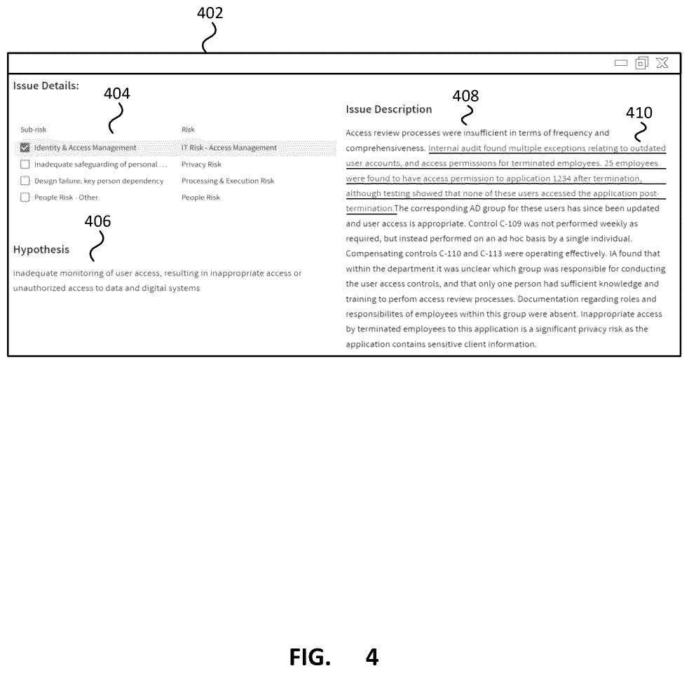

FIG. 3 depicts a system for automatic labelling of audit information. The system 300 is depicted as a single server; however, it will be appreciated that the system may be provided as one or more co-operating computing devices. The co-operating computing devices may be communicatively coupled together by one or more wired or wireless networks. As depicted, the server 300 comprises a processing unit 302 that processes instructions, one or more input/output interfaces 304 that allow additional devices or components to be coupled to the server, non-volatile storage 306 and volatile memory 308. Instructions and data may be stored in the non-volatile storage and/or the volatile memory. When the processor executes instructions stored in the memory, the server is configured to provide various functionality, including the audit issue labelling functionality 310.

The audit issue labelling functionality 310 can automatically label an issue description 312 prepared by an auditor with a plurality of relevant risks from a risk taxonomy 314 used by the auditors. As described above, for each risk/sub-risk in the risk taxonomy 314, one or more hypotheses can be generated 316 to provide risk label hypotheses 318. The risk label hypotheses are used to determine which of the sub-risks are relevant to the issue description.

The hypothesis generation functionality 316 can be used to generate the hypotheses. The functionality 316 may be provided as a manual process or semi-automated process. In the label classification task, the class labels are sub-risks in a risk taxonomy, which comprises a plurality of risks and sub-risks. An internal risk team's taxonomy documentation includes definitions, or descriptions, for each Risk and Sub-risk. In entailment-based zero-shot text classification approaches such as that used in the automated risk labelling described herein, the class labels are converted to hypotheses. Hypotheses are inputs to the zero-shot classification model that typically take the form of “This text is about [class description]”. There are multiple methods of converting class labels to hypotheses for text classification. Two such approaches include writing a hypothesis as the name of the class label, or writing a hypothesis as the definition of the class label. The output and performance of zero-shot entailment models is sensitive to the approach taken during hypotheses creation. For the current risk labelling, class label definitions and descriptions were used as hypotheses. Initial manual testing revealed that the Sub-risk class names were often either too generic or overly detailed, producing poor results. For example, both “Inability to maintain or relocate operations to another physical location or geography during and after an incident”, and “Enterprise Architecture” are Sub-risk labels in the Risk taxonomy.

A set of hypotheses were created for each Sub-risk based on Internal Audit's Risk taxonomy definitions. In the cases where the Risk definition was overly long, detailed, or described multiple scenarios/outcomes, multiple hypotheses were written that were mapped to a single Sub-risk. When writing the hypotheses, similar phrasing, length, and grammar was used as much as possible. Each hypothesis began with negative phrasing (“failure through”) to indicate that the hypothesis should correspond to control failures or other process failure within the Issue description. This helped to ensure that the model scores were differentiable between neutral control descriptions, such as auditors describing the general control environment and processes that were tested, and negative control descriptions, such as auditors describing control failures and deficiencies.

For most Sub-risks, one to four hypotheses were created. It will be appreciated that certain risks in the risk taxonomy do not include any sub-risks in which case the hypotheses can be generated from the risk description. Further, certain sub-risks in the taxonomy may be omitted. For example, “Other” sub-risks may be included in the taxonomy and are intended as catch-all category for issues that do not fall in any of the other risks. Such sub-risks may not be included as there is no useful description.

An example of an internal audit team's Risk definition, Sub-risk definition, and the corresponding hypotheses are shown below.

### Risk:

Privacy Risk: The risk of improper creation or collection, use, disclosure, retention or destruction of Personal Information.

### Sub-Risk:

Inadequate safeguarding of personal information: There is a risk that personal information of clients or employees are not appropriately managed or safeguarded throughout the information lifecycle in accordance with privacy principles and regulatory requirements. This failure may be intentional or unintentional.

### Hypotheses:

failure through mismanagement or inadequate safeguarding of personal information of clients or employees
failure through the improper collection, disclosure, retention or destruction of personal information
failure through inappropriate collection, sharing, disclosure or release of confidential client or employee data.
failure through inadequate compliance with consumer privacy regulatory requirements

In addition to the primary hypothesis descriptions, secondary hypothesis descriptions can be generated. As described above, the primary hypotheses may be generated using failure of control or process language. Some issue descriptions may not have a clear point of failure, which make the use failure based-hypothesis difficult for determining labels. These issue descriptions may not match with, or match with a low level of probability, any label hypotheses. In order to more accurately label such issues, a secondary set of hypotheses can generated from the primary hypotheses set by removing negative sentiment wording, such as failure, inadequate, inefficient, incorrect.

It will be appreciated that the hypothesis labels only need to be generated once, although the hypothesis labels can be updated to reflect an updated taxonomy or adjust existing hypothesis labels. The issue description 312 and label hypotheses 318 are provided to an automatic audit labelling functionality 320. The issue description 312 is provided as issue text 322 and the label hypotheses 318 are provided as a plurality of risk label hypotheses 324, each of which is associated with a particular risk or sub-risk in the risk taxonomy. Input generation functionality 326 receives the issue text 322 and risk label hypotheses 324 and generates a plurality of issue description: hypothesis pairs 328 that are provided as input to the zero-shot classifier 230.

The input generation 326 may clean the issue description in order to normalize the format. The text cleaning may remove formatting artifacts that can arise during the process of auditors writing Issue Descriptions in Microsoft Word, transferring the audit issue text to other systems and storage into SQL databases. The text cleaning procedure removes non-ascii characters, newline characters, ampersands, number signs, characters between </> and audit Case numbers. It also removes extra whitespace between punctuation. Further, the cleaning process may also replace abbreviations and/or acronyms with the complete words.

Each pair of premises, namely the cleaned issue text, and input hypothesis are tokenized with the tokenizer for the zero-shot model. The tokenized input 328 is provided to the zero-shot classifier 330. The zero-shot classifier may be based on a pre-trained large language model. For example, the language model may be the bart-large model (bart-large-mnli) which may be fine-tuned with a natural language inference dataset (MultiNLI). It will be appreciated that other language models and/or fine-tuning may be used for the zero-shot classifier.

In zero-shot textual entailment approaches, the classification task is typically framed as a natural language inference (NLI) problem. The task of an NLI problem is: Given a textual premise P, infer whether a given hypothesis His implied by (entailment), irrelevant to (neutral), or contradicted (contradiction) by the premise. In this way, textual input can be classified into relevant categories by considering the probability of entailment.

The zero-shot classifier model 330 is run on each tokenized hypothesis/premise pair 328. Scoring each hypothesis/premise pair separately ensures the relationship between risk classes is ignored, which is advantageous in this use-case as not all labels are independent. For each hypothesis, the zero-shot model outputs a sequence of logits 332, corresponding to “entailment”, “neutral”, and “contradiction”. The logits 332 output from the model 330 can be further processed by post processing functionality 334. The post processing may reduce the logit to a binary case for example by removing the neutral logit or adding it to the contradiction logit. The neutral logit can be removed or combined and the remaining entailment and contradiction logits can be converted to probabilities. The probabilities can be converted in various ways, including with a Softmax function. For each premise/hypothesis pair, a hypothesis score 336 can be output, which may be provided as the entailment probability*100. Once the hypothesis scores are provided for all premise/hypothesis pairs, the risk labels can be filtered by label filtering functionality 338.

The filtering process of the filtering functionality 338 outputs the top sub-risks for each provided Issue description premise. As described above, multiple hypotheses may be associated with a single sub-risk, and the model outputs of these hypotheses are aggregated at the sub-risk level, with the maximum score of all hypotheses for a sub-risk selected to be the overall score for that Sub-risk. It is possible to use other aggregation techniques such as averaging.

For each Issue, the output can be aggregated and filtered at the Risk level to the top 5 scoring Sub-risks for each Risk. The filtering may also filter erroneous model labels using one or more keyword filters. The Internal Audit definitions of “model” and “third party” may be precise and audit-specific, and can be very different from the semantic meaning of those phrases in common English. Initial empirical testing found that the bart-large-mnli model could not reliably distinguish between what auditors would consider a model in terms of Model Risk, versus what would be considered a formula or calculation and so not applicable to Model Risk. Similar issues were encountered with terms related to Third Party Risk, both of which led to high false positive rates for hypotheses relating to these Risks. As a solution, a simple keyword filter may be applied such that Model Risk and Third Party Risk labels are removed from the data when the Issue description text does not contain specific terms.

Further filtering may be done to remove any labels that do not have a hypothesis score above a minimum Sub-risk threshold score (Sₘᵢₙ). Sₘᵢₙ may be set to 50. An issue maximum score (Iₘₐₓ) for each issue can be determined as the maximum sub-risk score across all risks for the issue. The results may further filter the results to ensure the Issue maximum score is above an Issue threshold score of 65.

The data for each Issue may further be filtered on a difference between the Sub-risk score and the Issue maximum score, known as the Sub-risk score difference threshold (S_{diff}). The Sub-risks are filtered such that S_{diff}≤20.

The Sub-risks may then be filtered to include a number, such as 6 of top Sub-risks for each Issue. Issues that are input to the model but do not have output Risk score that fulfill the filtering criteria, such as the filtering criteria described above may be considered “unlabeled”.

It is desirable for the automatic audit labelling to provide Sub-risk level labeling granularity to auditors, as well as labeling with multiple different Risk classes. However, some Risks contains a large number of Sub-risks, and in the case that these Sub-risks are all highly scored by the model, only the sub-risks of a single risk may be presented to an auditor. It may not be desirable to allow a single risk type to dominate the output to auditors. In general, a larger diversity of Risks within the model's output are more informative to auditors, as well as more actionable in the business purpose context. In order to provide a number of different risks in the labelling output, the sub-risks for an individual risk may be limited, or filtered, to some number, such as 5 or less, that is less than the total number of top sub-risks output by the automatic labelling. Since the sub-risks are filtered to the top 5 for each risk, and typically more than 5 sub-risks are output, often at least two different risks will be included in the output 340.

The filtering process described above may filter out all of the labels for an issue. In such cases, or in the case where insufficient labels remain after filtering, the issue may be relabeled 342 using the secondary hypotheses in the label hypotheses 318. The secondary labelling process is the same as that described above; however, the input generates the premise: hypothesis pairs are generated using the secondary hypotheses. The results from the initial labelling and re-labelling can be combined together and output 340.

The output may be stored and used by a user interface 344 to allow the issues and labels to be presented to auditors. The user interface may allow issues, and labels to be reviewed by an auditor or other user. The user interface may highlight relevant portions of the issue text that led to the respective labelling.

The values of these thresholds were determined by measuring the dependence of each empirical threshold on two metrics. For these measurements the primary set of Risk hypotheses used by the first pass labelling, were used. These metrics were:
The number of Issues unlabeled by the model (unlabeled fraction). Issues that are removed during the Filtering Procedure are considered unlabeled by the model.
The fraction of labeled Issues that “match” the manual Risk label (match fraction). We consider the model's output to be a match with the manual label if the corresponding Risk of any of the model's top 6 Sub-risks matches the manual Risk label. We have chosen to assess label matching at the Risk level rather than the Sub-risk level due to the quality of the manual Sub-risk labels. Upon review, we have found that a large fraction of the manual Sub-risk labels are either not appropriate for the Issue description, or not the most appropriate.

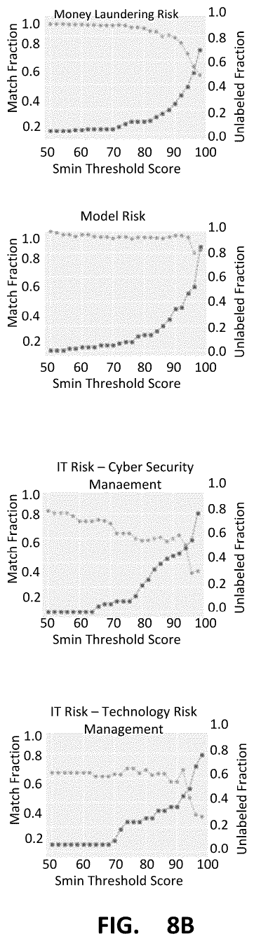

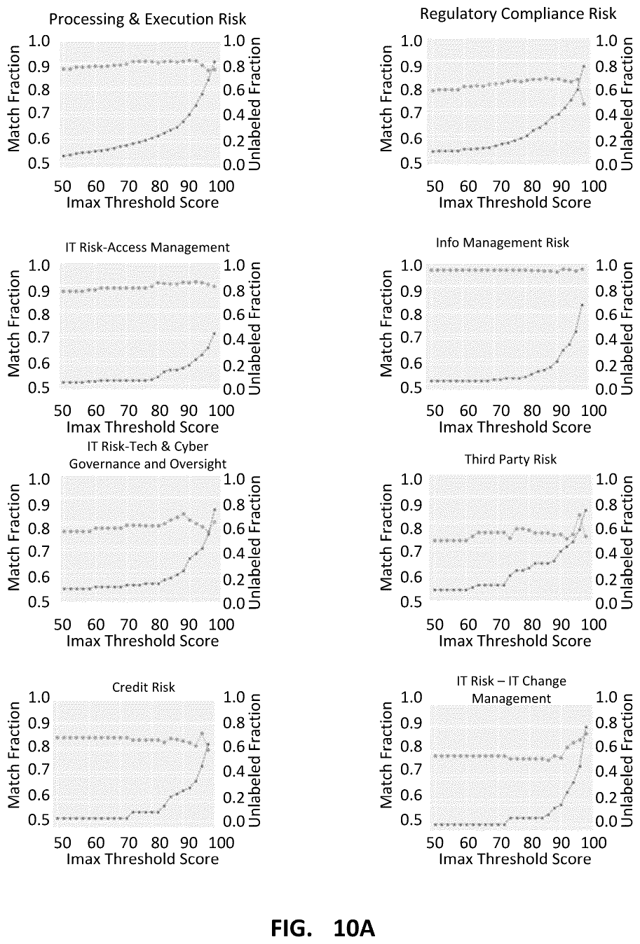

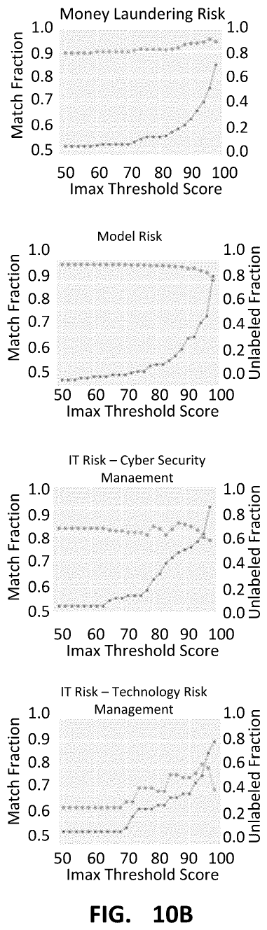

The match fraction was maximized under the constraint that the unlabeled fraction was <0.1. The graphs of these thresholds used for filtering for various sub-risks are depicted in FIGS. 8A-11B. In the graphs of FIGS. 8A, 8B and 10A, 10B, the line at the top at the left side of the graph represents the match fraction and the line at the bottom at the left side of the graph represents the unlabeled fraction.

For the minimum Sub-risk Threshold (Sₘᵢₙ), depicted in FIGS. 8A, 8B, overall, for risk category there was no increase in match fraction with increasing minimum sub-risk (Sₘᵢₙ) threshold score value. Therefore an Sₘᵢₙ threshold score of 50 was selected. In FIGS. 8A, 8B the graphs for Match Fraction of Issue, along the left axis, vs. Minimum Sub-risk Threshold score are depicted along with the Unlabeled Fraction of Issues, along the right axis, vs. Minimum Sub-risk Threshold Score. Risk categories with more than 50 samples are shown.

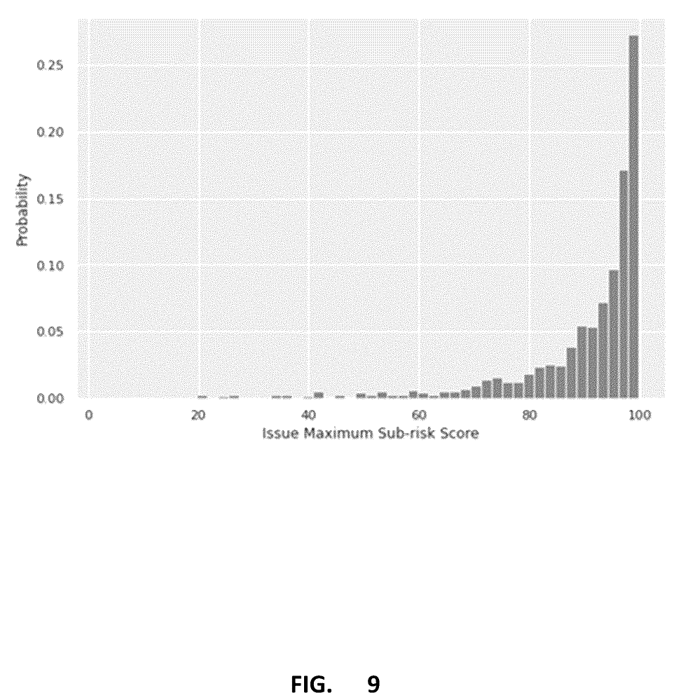

FIG. 9 depicts the model scoring distributions of individual Issues, which as can be seen were not uniform. FIG. 9 depicts a Histogram of Issue Maximum Sub-risk Scores. In particular, a significant fraction of Issues (˜0.3) had maximum Issue sub-risk scores (Imax) less than 90. One possible source of this uneven scoring distribution is that audit Issue descriptions vary greatly in length (˜20 to 1100 words), writing style, and level of technical detail.

The model output for Issues with Iₘₐₓ<50 were discarded, corresponding to the previously defined minimum Sub-risk threshold. Upon inspection, it was observed that for many Issues with 50<Iₘₐₓ<90 the model labels were appropriate for the Issue and appeared of good quality, but there was not a clear threshold point. To find an appropriate Iₘₐₓ threshold, the match fraction was maximized, given a constraint of the unlabeled fraction ≤0.1. To determine the optimal threshold, the match fraction and unlabeled fraction across Risk categories with more than 30 samples, according to manual labels, were measured as a function of Iₘₐₓ threshold score, as depicted in FIGS. 10A, 10B. FIGS. 10A, 10B depicts a graph with (Left axis) Match Fraction of labeled Issues vs. Issue threshold (Iₘₐₓ) and (Right axis) Unlabeled Fraction of Issues vs. Issue threshold (Iₘₐₓ). Risk categories with more than 30 samples are shown. For each Risk category, the Iₘₐₓ which maximized the match fraction under the constraint that the unlabeled fraction remains less than <0.1 was calculated. Then the weighted average of the Iₘₐₓ of each category was calculated, with the Risk category sample counts as weights. The optimal Iₘₐₓ threshold calculated from the development dataset was 65.

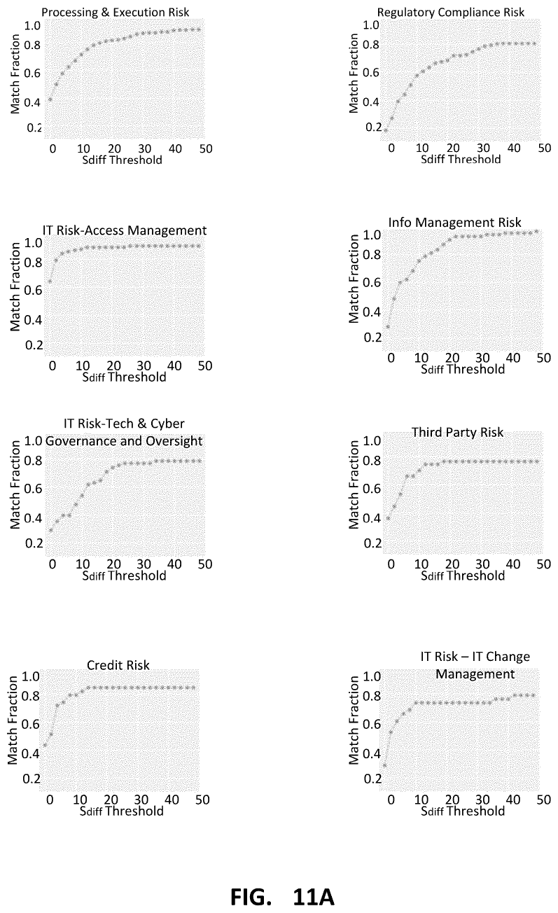

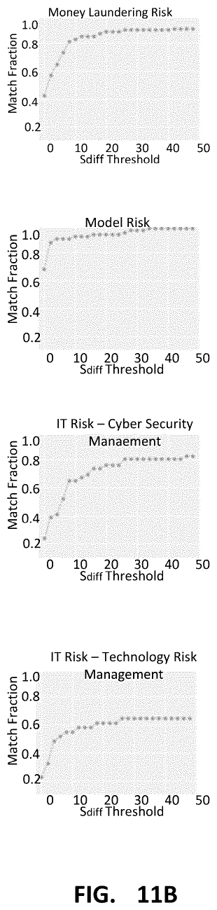

Due to limitations in the auditor-provided labels, the appropriateness of additional ZINC model labels assigned to an Issue may not be easily evaluated. For the model's business application, it is advisable to limit erroneous risk labels assigned to an Issue (false positives). As previously stated, the model output is the top 6, although other numbers are possible, Sub-risk labels for an Issue, provided they fall above the minimum Sub-risk threshold. For those top 6 Sub-risks, a threshold on the difference between the Sub-risk score and the maximum Issue Sub-risk score (S_{diff}) was also imposed. The intent for this threshold is to reduce any inappropriate Sub-risks as model output to auditors by removing lower scoring hypotheses in a normalized way across Issues. The label match fraction as a function of the threshold S_{diff} was measured using the previously calculated optimal values of the Iₘₐₓ and Sₘᵢₙ thresholds, as shown in FIGS. 11A, 11B. FIGS. 11A, 11B depicts graphs of Match Fraction of Issues vs. Score Difference Threshold. Risk categories with more than 30 samples are shown.

Apart from Processing & Execution Risk and Regulatory Compliance Risk, each Risk category appears to plateau to an approximately constant match fraction at S_{diff}<=20. The S_{diff} threshold chosen from the development dataset used in evaluating the various thresholds is 20.

As described above, the automatic audit labelling can provide a number of relevant risk/sub-risk labels for an issue. While providing a plurality of labels for an issue is useful, it may also be useful to be able to highlight relevant portions of the issue text to the labels. A user interface can be provided that allows different labels to be selected and the relevant portion of the text highlighted to the auditor.

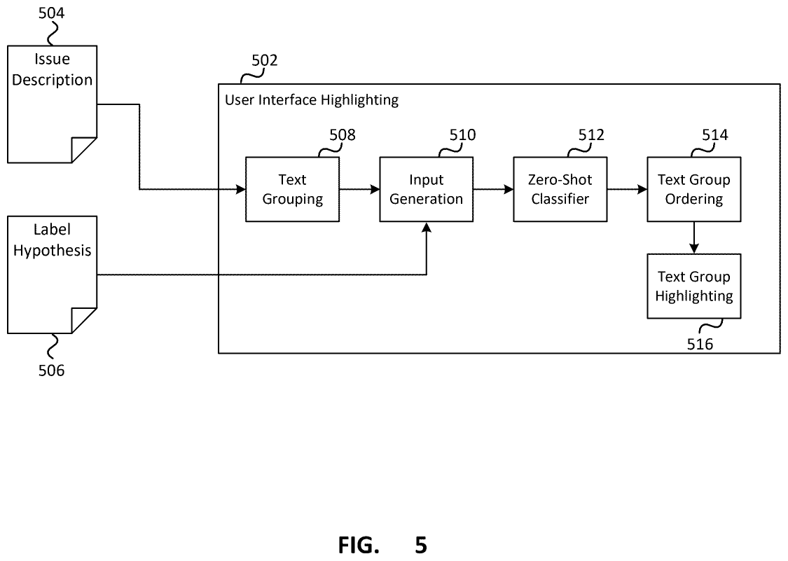

FIG. 4 depicts a user interface display highlighting relevant portions of audit information. As depicted, the user interface display 402 may present various information for a particular issue. The issue to be displayed may be selected in various ways, including using other user interface displays. The user interface display 402 may present, and select, the different risk/sub-risk labels 404 assigned to the issue by the automatic audit labelling functionality. The hypothesis 406 used for the risk/sub-risk label may also be presented. The issue text 408 may be presented and the relevant portion, or most relevant portion, of the issue text to the selected risk/sub-risk label highlighted 408. The highlighting is depicted as underlining the relevant text, although various highlighting techniques may be used. The process for identifying the relevant text portions of the issue text are described further below.

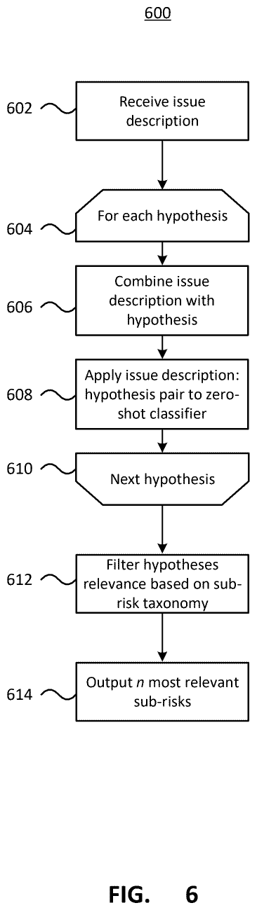

FIG. 5 depicts a portion of a user interface that can be used in a system such as that depicted in FIG. 3. The user interface highlighting functionality 502 depicted in FIG. 5 can be used to provide a user interface such as that depicted in FIG. 4. As depicted, the issue text 504 and a label hypothesis 506 of the risk/sub-risk label for highlighting is provided to the user interface highlighting functionality 502. The issue text is provided to text grouping functionality 508 that generates one or more text groupings from the issue text. The text groupings are the portions of the issue text that may be highlighted in the user interface. The text groupings may be generated by using individual sentences within the issue text as a text group. Other techniques may be used to generate the text groupings. For example, the input text string is split into the component sentences. For any sentence that is less than, for example 70 characters in length, the sentence may be appended to the previous sentence string. Consecutive pairwise combinations of sentences are created to form text groups. In the case of very long sentences, for example greater than 300 characters, the sentence itself forms the text group.

The generated text groupings are provided to input generation functionality 510 that generates a plurality of premise: hypothesis pairs using each text group and the hypothesis text. The pairs are provided to the zero-shot classifier 512 to score the relevance of each text group to the hypothesis. The model may score each text group on positive and negative phrasings of the selected hypothesis, which may be used in the first pass labelling and second pass re-labelling as described above. The maximum score of the two hypotheses phrasings may be used as the risk-text group score. The text groupings may be ordered 514 based on the scores and the results used to highlight the relevant text groupings. The highlighting may be provided in various ways, such as underlining the top-ranked text group, or using a display color based on the scores, etc.

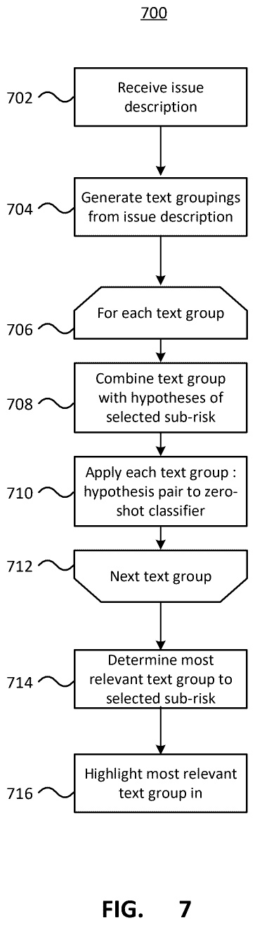

FIG. 6 depicts a method of automatically labelling audit information. The method 600 may be implemented in a computing system by executing instructions stored in a memory by a processor. The method receives an issue description (602). The issue description may be text prepared by an auditor that has been further processed to clean the text. The cleaning may remove punctuations, other artifacts, abbreviations, acronyms, etc.

In addition to the issue description, a plurality of risk/sub-risk hypotheses are received and for each hypothesis (604), the hypothesis and issue description are combined together and tokenized (606). The tokenized input pair are provided to the zero-shot classifier (608) to score the relevance of the hypothesis text to the issue description. The next hypothesis (610) is processed and once all of the issue description: hypothesis pairs scored, the results can be filtered (612) to identify the top risks/sub-risks. The filtering process may result in some issue descriptions no longer being associated with any risk/sub-risks in which case the issue description can be re-labeled using a secondary hypothesis. Once the results are filtered, the results can be output to one or more downstream processes (614). The process may output a set number, n, of results, such as the top 6, although other numbers of results can be provided. The downstream processes may include, for example, storing the results, presenting the results, aggregating the results, etc.

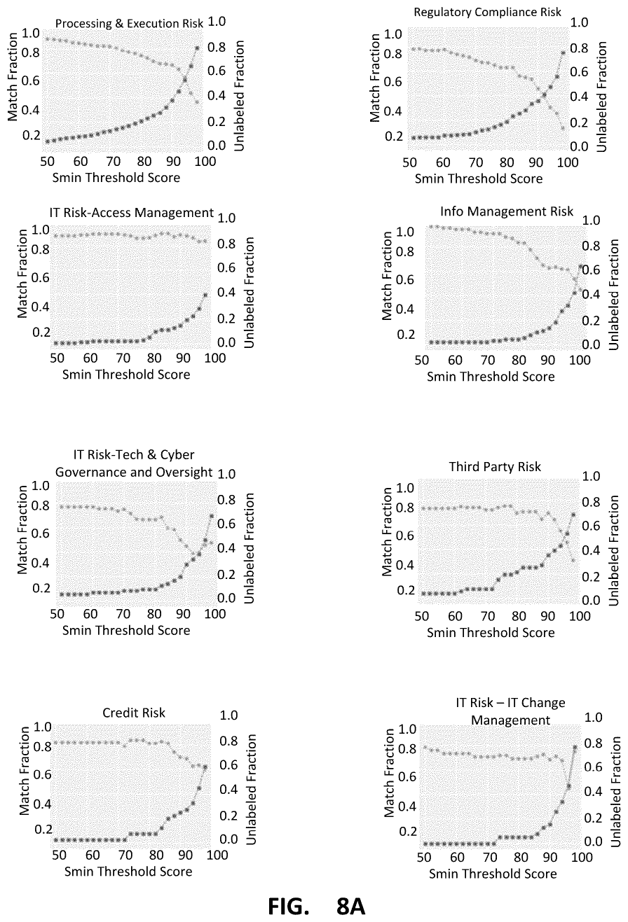

FIG. 7 depicts a method of highlighting relevant portions of audit information. The method 700 may be implemented in a computing system by executing instructions stored in a memory by a processor. The method 700 may be used to identify text portions within an issue description to be highlighted for a particular risk/sub-risk label. The method receives an issue description (702), which may be cleaned text prepared from an auditor's text of an issue identified in an audit. The issue text is used to generate text groupings (704), which can be generated as described above. For each text group (706), the text group is combined with the hypothesis being considered (708) and the pair applied to the zero-shot classifier to generate a text grouping score for the hypothesis (710). Although depicted as applying a single hypothesis to each group text, when a risk/sub-risk is associated with primary and secondary hypothesis, both hypothesis can be scored against each text group, and the highest score used for the text group score. Once all of the text groups (712) are scored, the scores are used to determine the most relevant text group to the hypothesis (714), which may be simply by the text grouping with the highest score. The most relevant text grouping may then be highlighted (716) for example using the font, color, underlining, etc. Further, rather than highlighting only the most relevant text group, the scores may be used to provide highlighting of additionally relevant text groupings. For example, the scores may be used to determine a color or shade to highlight the text groupings with.

The above has described labelling issue descriptions using a trained model, such as the bart-large-mnli model, which is run on each tokenized hypothesis/Issue pair and results in a set of hypothesis scores for each of the sub-risks. The results are filtered to provide the top risks. As described further below, the filtering procedure may be removed and replaced with an alternative filtering procedure using the generative large language model, such as mistral-7b-instruct or other generative large language models. The generative LLM model responses may be obtained in various ways such as through an API call to AWS Sagemaker which may be hosted and maintained by internal computational resources or by external computational resources. The hyperparameters used for the mistral model are the default parameters on this hosted version. In particular, temperature is set to 0 and max_new_tokens is set to 275. The particular hyperparameters of the generative LLM, whether mistral or other generative models, may be adjusted. The generative LLM filtering procedure uses the LLM to remove irrelevant hypotheses/sub-risks through comparison of the Issue text description to the sub-risk hypothesis. The generative LLM filtering is used to verify the relevance of the issue to the hypotheses. The initial model scoring of issues to hypothesis may vary greatly, in general, the top-scoring sub-risks are more likely to be relevant to an Issue description than low-scoring sub-risks. With such a large number of sub-risks used as input, it is likely that the verification generative LLM will produce at least some false positives, and may generate more than 6 positive sub-risks as output. The initial scoring of the hypotheses/sub-risks that are determined to be relevant can then be used for the ordering of top results, and selecting the top sub-risks to output.

FIG. 12 depicts a further system for automatic labelling of audit information. The system is similar to that depicted in FIG. 3; however, the filtering component 338 is replaced with a verification model. The functioning of similar components are not described in further detail below. The zero-shot classifier 330 determines a score for each sub-risk hypothesis. The post processing aggregates the data for each Issue such that the maximum score hypothesis for each sub-risk is kept. The data for each issue is further processed to filter based on the difference between the hypothesis score and the Issue's top hypothesis score. The hypotheses are filtered such that the score difference ≤60.

The filtered hypothesis data for each issue may be converted to a set of prompts that request the verification model 1238 to compare the Issue text description to the hypothesis 1240. Although FIG. 12 depicts the hypothesis used for the verification model prompt as being the same as used for generating the input 326, it is possible to use a simplified version of the hypothesis text. These prompts are sent to the verification model 1238, and yes/no responses are generated for each prompt.

The data for each Issue may then be filtered based on the verification model's response. Cases in which the response is ‘no’ are removed. The top scoring, for example up to 6, sub-risks for which the response is ‘yes’ are selected for each Issue. This procedure using the verification model eliminates the requirement for the second pass re-labelling described above. As there is no filtering on a minimum score for each Issue, there is no fraction considered ‘unlabeled’ as in the process described above. In the verification model procedure, an Issue is considered unlabeled if no sub-risks remain after the verification model, that is all responses were ‘no’. The results after the verification model can then be displayed in a user interface as described above.

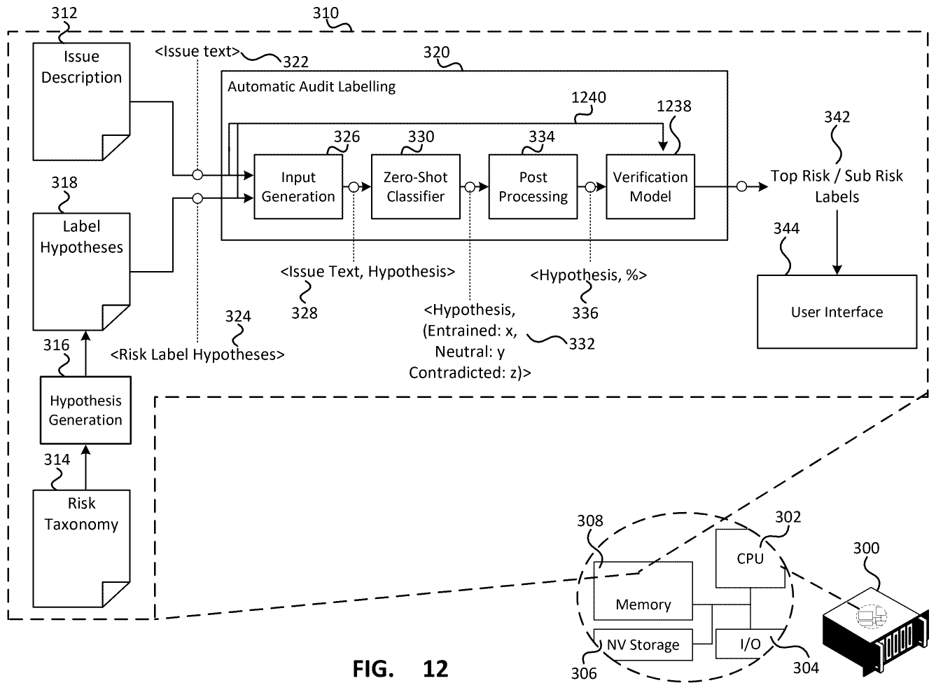

FIG. 13 depicts a method of automatically labelling audit information. The method 1300 is similar to that described above. The method 1300 may be implemented in a computing system by executing instructions stored in a memory by a processor. The method receives an issue description (1302). The issue description may be text prepared by an auditor that has been further processed to clean the text. The cleaning may remove punctuations, other artifacts, abbreviations, acronyms, etc. In addition to the issue description, a plurality of risk/sub-risk hypotheses are received and for each hypothesis (1304), the hypothesis and issue description are combined together and tokenized (1306). The tokenized input pair are provided to the zero-shot classifier (1308) to score the relevance of the hypothesis text to the issue description. The next hypothesis (1310) is processed and once all of the issue description: hypothesis pairs scored, the results can be filtered based on whether or not the issue is determined to be relevant to hypothesis by a generative LLM used to verify the issue: hypothesis (1312). For the issues that are verified to be relevant to the hypothesis by the generative LLM, the top n results based on the classifier results can be output to one or more downstream processes (1314). The process may output a set number, n, of results, such as the top 6, although other numbers of results can be provided. The downstream processes may include, for example, storing the results, presenting the results, aggregating the results, etc.

When using generative LLM verification model, which as described above may be the mistral LLM, to compare Issue text descriptions to hypotheses, it may be expected for there to be a false positive rate in which the generative LLM incorrectly states that a hypothesis is applicable to an Issue. The generative LLM may not quantify the uncertainty/confidence in the output. Accordingly, the lowest scoring hypotheses from the initial scoring by the zero-shot classifier may not be provided to the generative LLM for further consideration. Removing the lowest scoring hypotheses may also reduce computation time significantly.

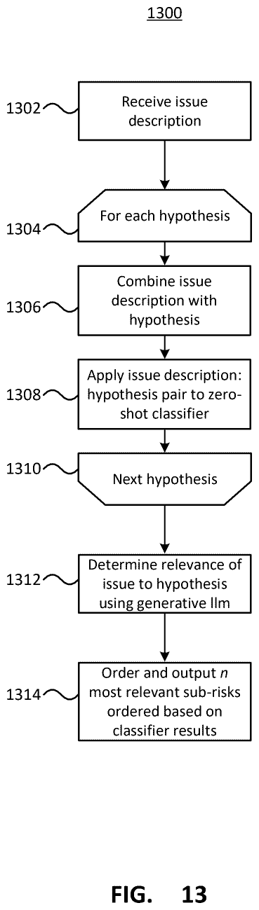

As depicted in FIG. 14, for each Issue, positive generative LLM responses are considerably more likely for highly ranked zero-shot classifier hypotheses. This shows that filtering out the lowest scoring hypothesis before the verification model is a sensible approach.

The prompts to the verification model combines an audit Issue description with a hypothesis as a ‘topic’. Multiple different wordings and audit examples were experimented with in the prompt. It was found that including phrasing requiring the ‘explicit mention’ of the topic in the Issue description within the prompt was helpful in terms of reducing false positives. The prompt used for comparing hypotheses to Issue text descriptions is defined as:
“[INST] Audit issue: ‘{Issue description}’
Is the topic ‘{hypothesis}’ explicitly mentioned in the audit issue? Answer using YES or NO. [/INST]”

This prompt uses a real Issue description, as the initial experimentation found that more detailed and realistic Issue descriptions produced better results than shorter/manually generated Issue samples. In the prompt engineering, it was found that the model output was sensitive to the wording of the central question of the prompt (in this case: “Is the topic ‘{hypothesis}’ explicitly mentioned in the audit issue?”). Some variations of this prompt that were tested include:
Is the topic ‘{hypothesis}’ mentioned in the audit issue?
Is the topic ‘{hypothesis}’ applicable to the audit issue?
Is the topic ‘{hypothesis}’ mentioned in the text?
Does the audit Issue mention the topic ‘{hypothesis}’?
Does the audit Issue explicitly mention the topic ‘{hypothesis}’?

During prompt engineering, a small sample of Issues (˜5) were selected from different audit teams and covering different risks. For the first Issue, the Issue description was read, and the applicable sub-risk hypotheses was selected as true positives as part of a test hypothesis set. A set of true negatives were added that were both conceptually ‘close’ to the true sub-risk label (i.e. another sub-risk from the same risk category as the true positive sub-risk) and ‘far’ from the true sub-risk label (i.e. completely unrelated sub-risks, additional statements unrelated to audit). The responses of the verification model were manually reviewed for different prompts using this test hypothesis set and discarded poor performing prompts. Good performing prompts (no false positives, no false negatives) were then subsequently tested and reviewed on additional Issues using the same process.

Once the best performing prompts were selected, an additional sample of Issues (˜5) were selected, and ran the verification model with those prompts using the top 50% of sub-risk hypotheses as scored by zero-shot classifier model (to reduce manual review time). The output of the model on those Issues was manually reviewed, and selected the final prompt that had the least number of false positives, while still capturing the (up to) top 6 true positives. The prompt engineering process was iterative, as also included adjustments to the wording of the hypotheses used in the prompt.

The hypotheses used for the verification model prompt comparison are generally more simplified versions of the hypotheses used for the zero-shot classifier model. In general, it was found that the long, detailed sub-risk descriptions used for zero-shot classifier produced a large number of false negatives when used in the verification model prompts. During prompt engineering, the verification model was asked to provide reasoning as to why the hypothesis was or was not mentioned in the text. In general, explanations provided by the model indicated that the hypothesis was too specific when compared to the audit Issue description.

Example responses for both the zero-shot classifier/verification model versions of a hypothesis are shown below:
zero-shot classifier hypothesis: “inadequate anti money laundering client due diligence (client identification, information gathering, ascertaining client identity, ongoing monitoring)”
verification model response: “NO. The audit issue is about ‘Inadequate due diligence process’ and ‘Missing client identification’, but does not specifically mention ‘inadequate anti money laundering client due diligence (client identification, information gathering, ascertaining client identity, ongoing monitoring)’.”
verification model hypothesis: “inadequate anti money laundering client due diligence”
verification model response: “YES.”

Adjusting the zero-shot classifier hypothesis to be less verbose generally improved the prompt results of the verification model.

Although the verification model appears to have good internal representations of the risks in Internal Audit's risk taxonomy (i.e. it can provide good descriptions of each risk type), it does not necessarily perfectly align with all sub-risk descriptions in the taxonomy. IA's taxonomy sub-risk descriptions often include specific examples of control failures that may not be clear from just the sub-risk name. For example, ‘People Risk—Other’ includes ‘implementation of employee recruitment and staffing processes’ in the sub-risk description. Therefore, it was elected to continue using the set of hypotheses as the input to the verification model prompt instead of the more generic sub-risk/risk name.

To assess robustness of the verification model approach, a modified set of a sample of 94 Issues were modified to include various typos. Sampled Issues span all risk categories. Typos were generated by modifying a random word in each sentence of the Issue descriptions with a random choice of string typo modifications from the Python package typo. These typos include modifications such as repeated characters, the additional of extra whitespace, adjacent character swapping etc.

The sub-risk label sets between original and typo-modified (perturbed) Issue descriptions were compared using the initial (zero-shot classifier+filtering) approach. It was found that in 73% of Issues the typo modifications resulted in a change in the label set of at least one sub-risk.

The influence of typos on the generated verification model responses were also measured. Using the original and typo-modified Issue descriptions, the verification responses (yes/no) were compared for ˜2500 hypothesis/Issue pairs. In only 1.3% of cases did the typo modifications affect the yes/no output of the generated response to the prompt, indicating a significant improvement over the zero-shot classifier.

Finally, the changes in predicted sub-risk/risk label sets (symmetric difference, Jaccard similarity) were measured for the revised model approach that uses both the zero-shot classifier and the verification model.

TABLE 1
Symmetric Difference between Original and
Perturbed Issue Prediction Label Sets

| Symmetric | Sub-risk | |
|---|---|---|
| Difference | Count | Risk Count |
| 0 | 37 | 52 |
| 1 | 26 | 28 |
| 2 | 21 | 11 |
| 3 | 4 | 0 |
| 4 | 4 | 1 |

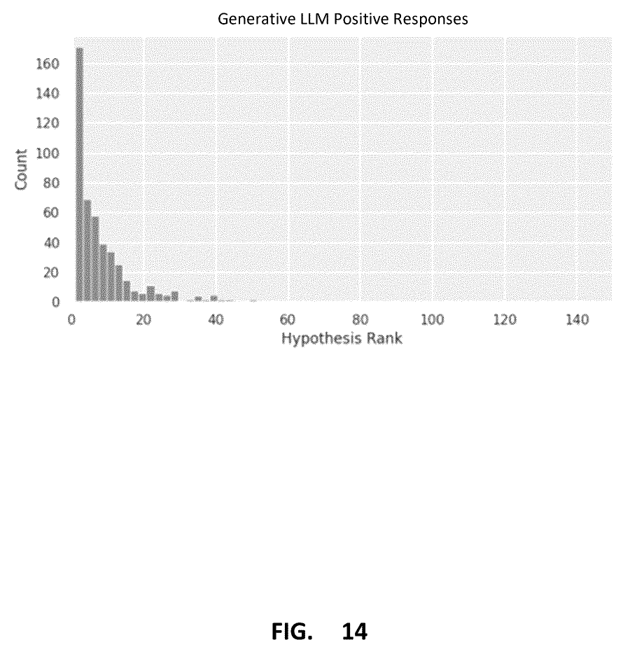

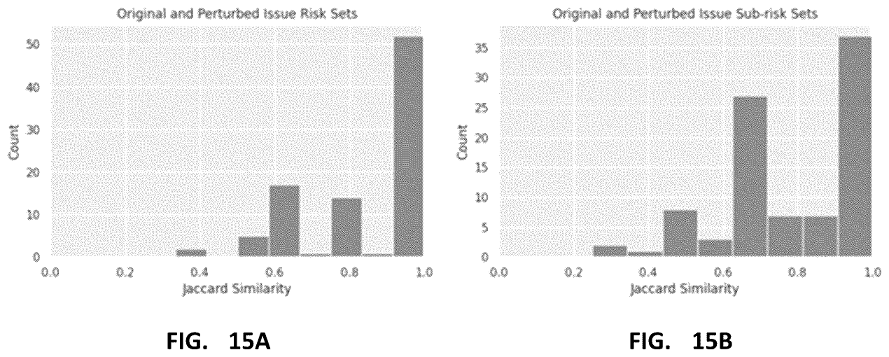

As can be seen from Table 1, the majority of Issues have a symmetric difference between the original and perturbed Issue label sets of 1 or less, even with a high number of introduced typo modifications. The changes in predicted label sets are almost entirely due to the zero-shot classifier component of the model. In the filtering procedure the number of sub-risks are limited to 6, although many Issues will have more than 6 potential labels. The final label set is sensitive to re-ordering of sub-risks that may occur due to scoring differences from the zero-shot classifier. In cases in which Issues have more than 6 potential sub-risk labels, there are typically a number of sub-risks which are applicable to the Issue description as written, but are very unlikely to be considered the most important topic by an auditor/human reader. In these cases, a re-ordering of the zero-shot classifier scores may not be a concern unless the most important risks are dropped from the label set. The Jaccard similarity between the sets at the sub-risk and risk level is shown in FIGS. 15A and 15B.

To assess the quality of the predicted label sets produced by the revised model, a sample of 90 Issues were selected to be manually assessed/annotated. Both false positive and false negatives were recorded for each Issue.

The match fraction between the risk label sets and the auditor labels from Metricstream was 0.75, which is similar to the observed match fractions for high-frequency risk categories during original model development.

Based on the manual annotation results, it was found that in 12% of Issues the model label set did not contain a relevant sub-risk (false negative). All of these lssue label sets did contain otherwise true positive sub-risk labels. When reviewing these lssue descriptions, it was found that in general the Issue length was shorter than average and the predicted label sets were smaller than the maximum of 6.

In 22% of Issues, the label set contained at least one sub-risk that was deemed not relevant to the Issue (false positive). In 6 cases the label set contained more than one false positive sub-risk. In our sample, 80% of the false positive labels were the lowest, or second-lowest ranked sub-risk attributed to an Issue.

In the set of Issues that contained at least one false positive sub-risk, 40% of the false positive sub-risks corresponded to true positive risk categories for that Issue. For example, an Issue may have a true positive label of Information Management Risk-Data Quality in the prediction set, and a false positive label of Information Management Risk-Data Accountability. This is not entirely unexpected as the language between sub-risks is often very similar, and the conceptual difference between those risks may be subtle. Additionally, the Issue may not contain a precise enough description to accurately distinguish between sub-risks. In the original model specification, the number predicted individual sub-risks were limited from a single risk to 4. Further limiting to the top, or top two sub-risks may be considered to reduce possible false positives. Changes to the filtering procedure to remove a higher proportion of low-scoring hypotheses prior to applying the verification model may also improve the performance.

It will be appreciated by one of ordinary skill in the art that the systems, methods and components shown in the figures can include components not explicitly depicted. For simplicity and clarity of the illustration, elements in the figures are not necessarily to scale, are only schematic and are non-limiting of the elements structures. It will be apparent to persons skilled in the art that a number of variations and modifications can be made without departing from the scope of the invention as defined in the claims.

Although certain components and steps have been described, it is contemplated that individually described components, as well as steps, can be combined together into fewer components or steps or the steps can be performed sequentially, non-sequentially or concurrently. Further, although described above as occurring in a particular order, one of ordinary skill in the art having regard to the current teachings will appreciate that the particular order of certain steps relative to other steps can be changed. Similarly, individual components or steps can be provided by a plurality of components or steps. One of ordinary skill in the art having regard to the current teachings will appreciate that the components and processes described herein can be provided by various combinations of software, firmware and/or hardware, other than the specific implementations described herein as illustrative examples.

The techniques of various embodiments can be implemented using software, hardware and/or a combination of software and hardware. Various embodiments are directed to apparatus, e.g. a node which can be used in a communications system or data storage system. Various embodiments are also directed to non-transitory machine, e.g., computer, readable medium, e.g., ROM, RAM, CDs, hard discs, etc., which include machine readable instructions for controlling a machine, e.g., processor to implement one, more or all of the steps of the described method or methods.

Some embodiments are directed to a computer program product comprising a computer-readable medium comprising code for causing a computer, or multiple computers, to implement various functions, steps, acts and/or operations, e.g. one or more or all of the steps described above. Depending on the embodiment, the computer program product can, and sometimes does, include different code for each step to be performed. Thus, the computer program product may, and sometimes does, include code for each individual step of a method, e.g., a method of operating a communications device, e.g., a wireless terminal or node. The code can be in the form of machine, e.g., computer, executable instructions stored on a computer-readable medium such as a RAM (Random Access Memory), ROM (Read Only Memory) or other type of storage device. In addition to being directed to a computer program product, some embodiments are directed to a processor configured to implement one or more of the various functions, steps, acts and/or operations of one or more methods described above. Accordingly, some embodiments are directed to a processor, e.g., CPU, configured to implement some or all of the steps of the method(s) described herein. The processor can be for use in, e.g., a communications device or other device described in the present application.

Numerous additional variations on the methods and apparatus of the various embodiments described above will be apparent to those skilled in the art in view of the above description. Such variations are to be considered within the scope.

What is claimed is:

1. A method of automatically labelling issues from an internal audit, the method comprising:
receiving an issue description comprising a text description of an internal audit issue;
combining the text description with a plurality of hypotheses texts to generate a plurality of description: hypothesis pairs, each of the plurality of hypotheses texts associated with a sub-risk description for a sub-risk in a risk taxonomy;
applying each of the description: hypothesis pairs to a zero-shot classification model to determine a label score for the sub-risk associated with the hypothesis;
determining relevance of each sub-risk in the risk taxonomy to the issue description; and
outputting a plurality of relevant sub-risks associated with the issue description.

2. The method of claim 1, wherein determining the relevance of each sub-risk in the risk taxonomy to the issue description comprises:
applying a generative large-language model (LLM) to the issue description and the hypothesis texts to determine if the issue description is relevant to the hypothesis text.

3. The method of claim 2, wherein only issue descriptions with a label score above a threshold are applied to the generative LLM.

4. The method of claim 3, wherein the hypothesis text applied to the generative LLM is a simplified version of the hypothesis text applied to the zero-shot classification model.

5. The method of claim 1, wherein determining the relevance of each sub-risk in the risk taxonomy to the issue description comprises:
filtering each of the label scores to identify a top n labels for the issue description, where n is a whole number greater than 1.

6. The method of claim 5, wherein the filtering comprises:
aggregating a plurality label scores for hypothesis associated with the same sub-risk; and
filtering on the aggregated label scores.

7. The method of claim 6, wherein the filtering further comprises:
for all hypothesis associated with sub-risks grouped by a common risk, filtering to a top m sub-risks for the risk grouping, where m is a whole number less than n.

8. The method of claim 1, further comprising cleaning the issue description to normalize the issue description.

9. The method of claim 1, wherein each of one or more of the sub-risks in the risk taxonomy are associated with a plurality of hypothesis.

10. The method of claim 9, wherein the plurality of hypothesis are based on different portions of the sub-risk description in the risk taxonomy.

11. The method of claim 9, wherein the plurality of hypothesis are based on different phrasing of a same portion of the same sub-risk description in the risk taxonomy.

12. The method of claim 1, further comprising:
receiving a hypothesis;
determining relevant portions of the issue description to the selected hypothesis; and
highlighting the relevant portions of the issue description in a user interface display.

13. The method of claim 12, wherein determining the relevant portions of the issue description comprises:
generating a plurality of text groupings based on pairings of sentences in issue description;
applying each of text groupings, combined with the hypothesis, to the zero shot classifier to provide a text group scoring for the hypothesis; and
selecting the text grouping with the highest text group scoring for highlighting.

14. A non-transitory computer readable medium storing instructions, which when executed by a processor of a computing device configure the computing device to perform a method comprising:
receiving an issue description comprising a text description of an internal audit issue;
combining the text description with a plurality of hypotheses texts to generate a plurality of description: hypothesis pairs, each of the plurality of hypotheses texts associated with a sub-risk description for a sub-risk in a risk taxonomy;
applying each of the description: hypothesis pairs to a zero-shot classification model to determine a label score for the sub-risk associated with the hypothesis;
determining relevance of each sub-risk in the risk taxonomy to the issue description; and
outputting a plurality of relevant sub-risks associated with the issue description.

15. The computer readable medium of claim 14, wherein determining the relevance of each sub-risk in the risk taxonomy to the issue description comprises:
applying a generative large-language model (LLM) to the issue description and the hypothesis texts to determine if the issue description is relevant to the hypothesis text.

16. The computer readable medium of claim 15, wherein only issue descriptions with a label score above a threshold are applied to the generative LLM.

17. The computer readable medium of claim 16, wherein the hypothesis text applied to the generative LLM is a simplified version of the hypothesis text applied to the zero-shot classification model.

18. The computer readable medium of claim 14, wherein determining the relevance of each sub-risk in the risk taxonomy to the issue description comprises:
filtering each of the label scores to identify a top n labels for the issue description, where n is a whole number greater than 1.

19. The computer readable medium of claim 18, wherein the filtering comprises:
aggregating a plurality label scores for hypothesis associated with the same sub-risk;
filtering on the aggregated label scores; and
for all hypothesis associated with sub-risks grouped by a common risk, filtering to a top m sub-risks for the risk grouping, where m is a whole number less than n.

20. The computer readable medium of claim 14, wherein each of one or more of the sub-risks in the risk taxonomy are associated with a plurality of hypothesis, wherein the plurality of hypothesis are based on one or more of:
different portions of the sub-risk description in the risk taxonomy; and
different phrasing of a same portion of the same sub-risk description in the risk taxonomy.

21. The computer readable medium of claim 14, further comprising:
receiving a hypothesis;
determining relevant portions of the issue description to the selected hypothesis; and
highlighting the relevant portions of the issue description in a user interface display,
wherein determining the relevant portions of the issue description comprises:
generating a plurality of text groupings based on pairings of sentences in issue description;
applying each of text groupings, combined with the hypothesis, to the zero shot classifier to provide a text group scoring for the hypothesis; and
selecting the text grouping with the highest text group scoring for highlighting.

22. A computing system comprising:
a processor for executing instructions; and
a memory storing instructions, which when executed by the processor configure the computing system to perform a method according to claim 1.
